(19) United States
(12) Patent Application Publication
(10) Pub. No.: US 2026/0227302 A1
(43) Pub. Date: Aug. 6, 2026

(54) AUTOMATIC MEDICAL POUCH PEEL/TENSILE TESTING DEVICE

(71) Applicant: Charlie Webb, Solvang, CA (US)

(72) Inventor: Charlie Webb, Solvang, CA (US)

(21) Appl. No.: 19/043,302

(22) Filed: Jan. 31, 2025

(51) Int. Cl. G01N 3/08; G01N 1/28

(52) U.S. Cl. CPC G01N 3/08; G01N 1/286; G01N 2001/2873; G01N 2203/0017; G01N 2203/0091; G01N 2203/0417

(57) ABSTRACT

An automatic medical pouch peel/tensile testing device may comprise a cutting mechanism configured to automatically cut a medical pouch to prepare a test specimen. A loading mechanism may be configured to automatically load the test specimen into a testing apparatus. A peeling mechanism may be configured to apply a controlled increasing force to separate a seal of the test specimen. One or more sensors may be configured to monitor force applied during testing of the test specimen. A memory may be configured to store test data. A controller may be configured to control operation of the cutting mechanism, loading mechanism, and peeling mechanism. The controller may receive force measurements from the one or more sensors. The controller may store the force measurements in the memory. The device may improve accuracy and repeatability of medical pouch seal integrity testing by automating the specimen preparation, loading, testing, and data collection processes.

### CROSS REFERENCE TO RELATED APPLICATIONS

This application claims the benefit of U.S. Provisional Application No. 63/549,432, filed on Feb. 2, 2024, the entire contents of which are hereby incorporated by reference.

### FIELD OF THE INVENTION

The present invention relates to the field of testing methodologies for medical pouches to ensure that the seal created on the pouch is secure. More specifically, the invention relates to an automated device for performing ASTM F-88 Peel or tensile tests on medical pouches.

### BACKGROUND OF THE INVENTION

It is a problem in the art to provide consistent and accurate testing of medical pouches. Medical device manufacturers utilize a protective pouch called the “sterile barrier system” to ship their medical devices to the point of use, typically the surgical theater. There is an obvious risk to the patient's health in the event a medical pouch is compromised. Medical device manufacturers utilize a host of testing methodologies to ensure that the seal they created on the pouch is secure. The most common test is the ASTM F-88 Peel or tensile test, which is a destructive test that pulls apart the sealed area of the medical pouch and measures the force needed to open. This provides a useful metric for medical device packaging engineers to be assured that the pouch and device will make it safely to the point of care.

This destructive test methodology needs to be performed regularly to ensure that there is no breach in the value of the sealed area. Loading the specimen into conventional peel testers requires accuracy in order to gain valuable data. Most users of this equipment are lay employees not familiar with engineering protocols. The risk to the process is that the methodology may vary from operator to operator, causing a repeatability issue with this important metric. There is a need for an improved process that provides greater reliability, safety, and mitigates risk.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device and system of the present invention will remove user error by automatically cutting, loading, and peeling the pouch and monitor the process with on-board calibratable sensors. Removing the human connection to this precision test method will aid in developing accuracy and will further encourage more frequent test cadences. Data from each rapid tensile test will remain in the system's memory for data purge and evaluation by the engineering group and the quality management team.

Other objects and advantages of the present invention will be more readily apparent from the following detailed description when read in conjunction with the accompanying drawings.

### BRIEF DESCRIPTION OF THE DRAWINGS

FIG. 1 is a front perspective view from above and to the right of the automatic medical pouch peel/tensile testing device of the present invention.

FIG. 2 is a set of views of the device and system of FIG. 1, including a front right perspective view from above showing a control panel, a side elevational view showing legs, and a rear right perspective view from above in accordance with the present invention.

FIG. 3 is a side elevational view of the invention of FIG. 1 in accordance with the present invention.

FIG. 4 is a rear right perspective view from above of the invention in accordance with the present invention.

FIG. 5 is a schematic diagram showing the internal components of the device in accordance with the present invention.

FIG. 6 is an isometric view of the device labeled as 600 in accordance with the present invention.

FIG. 7 is an exploded view diagram of the device showing various components in accordance with the present invention.

FIG. 8 is a front view illustration of the device labeled as 800 in accordance with the present invention.

FIG. 9 is a left side view of the device labeled as 900 in accordance with the present invention.

FIG. 10 is a right side view of the device labeled as 1000 in accordance with the present invention.

FIG. 11 is a back view of the device labeled as 1100 showing various ports in accordance with the present invention.

FIG. 12 is a top view of the device labeled as 1200 in accordance with the present invention.

FIG. 13 is a detailed view of the control panel interface in accordance with the present invention.

FIG. 14 is a detailed view of the port panel in accordance with the present invention.

FIG. 15 is a side view of the installed cutting mechanism labeled as 1500 in accordance with the present invention.

FIG. 16 is a schematic side view of the installed cutting mechanism labeled as 1600 in accordance with the present invention.

FIG. 17 is an isometric view of the mechanical assembly labeled as 1700 in accordance with the present invention.

FIG. 18 is an exploded view of the mechanical assembly in accordance with the present invention.

FIG. 19 is a front view of the mechanical apparatus in accordance with the present invention.

FIG. 20 is a left view of the mechanical component in accordance with the present invention.

FIG. 21 is a right view of the mechanical assembly labeled as 2100 in accordance with the present invention.

FIG. 22 is a back view of the symmetrical mechanical device in accordance with the present invention.

FIG. 23 is a top view of the mechanical assembly labeled as 2300 in accordance with the present invention.

FIG. 24A-E are a series of diagrams illustrating the operation of the automatic pouch peel tester in accordance with the present invention.

### DETAILED DESCRIPTION OF THE INVENTION

The present invention relates to an automatic medical pouch peel/tensile testing device designed to perform ASTM F-88 Peel or tensile tests on medical pouches. The device automates the process of cutting, loading, and peeling medical pouches to test the integrity of their seals, removing human error and improving accuracy.

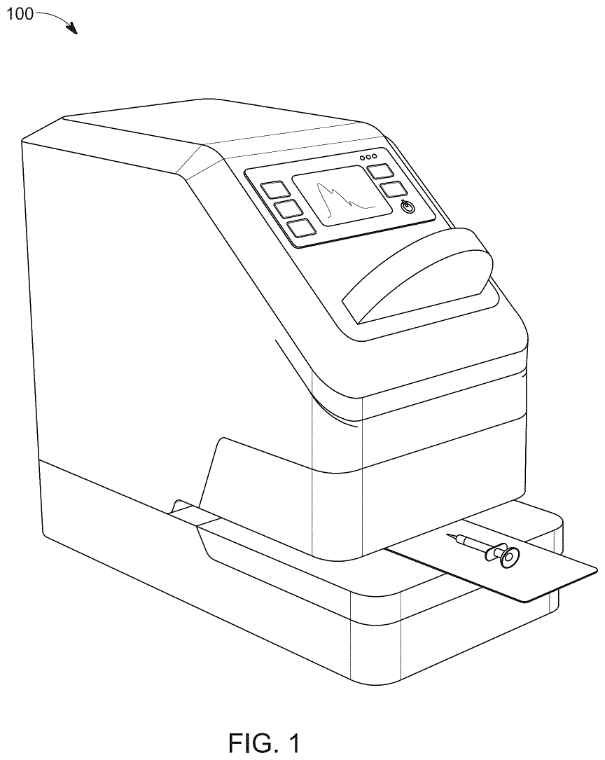

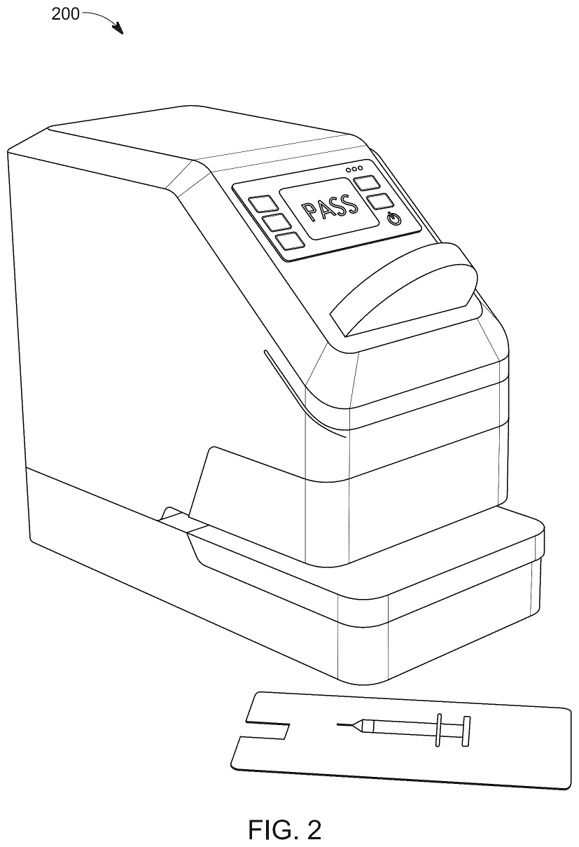

Referring to FIG. 1, a front perspective view from above and to the right of the automatic medical pouch peel/tensile testing device 100 is shown. The device 100 may have a rectangular shape with rounded edges and may include a touchscreen display panel on the upper surface. The touchscreen display panel may show a user interface with identifiable icons for easy operation.

As shown in FIG. 2, the device 100 may include a control panel, legs for stability, and a matte finish. The control panel may be located on the inclined top surface of the device, providing easy access and visibility to the user.

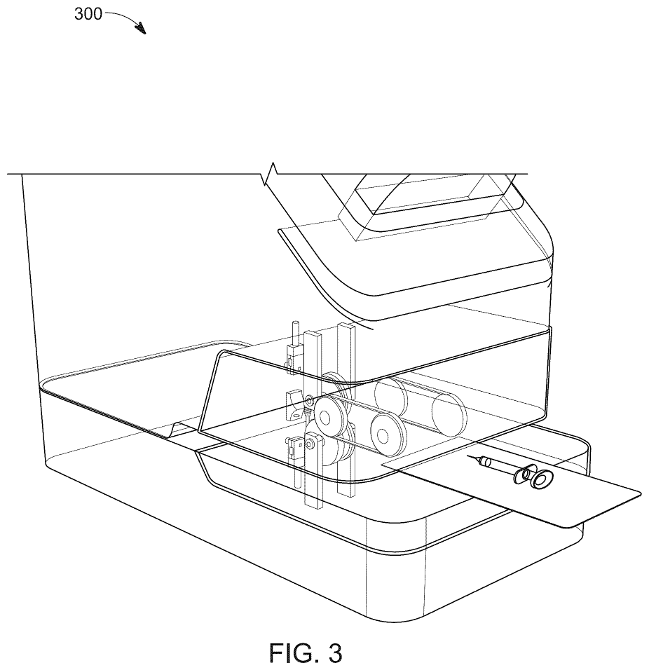

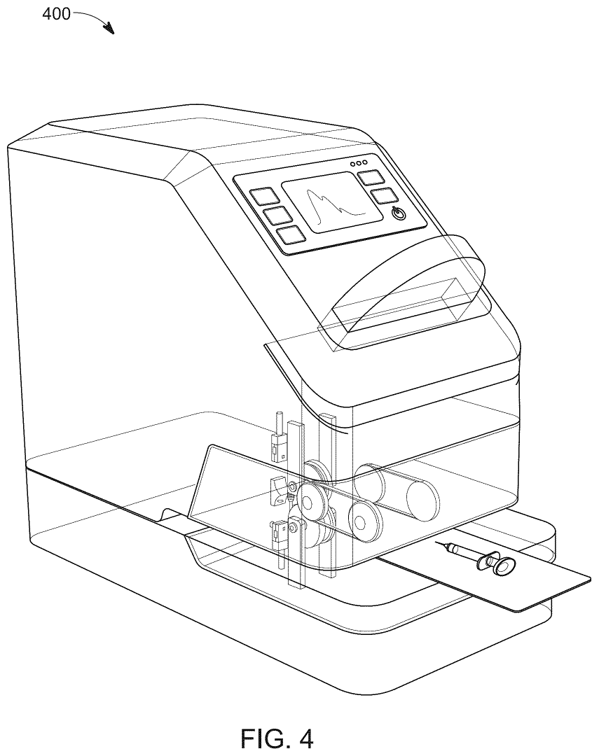

FIG. 3 illustrates a side elevational view of the device 100, clearly showing the legs that provide stability to the device during operation. These legs may be adjustable to ensure the device is level on various surfaces.

FIG. 4 depicts a rear right perspective view from above in accordance with the present invention.

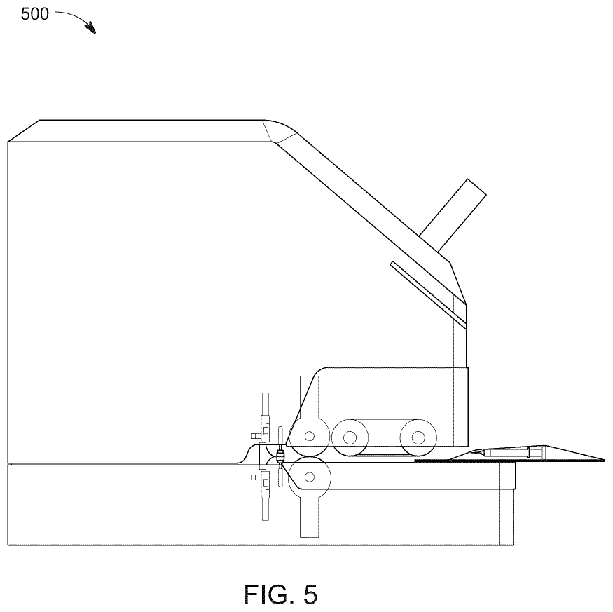

Referring to FIG. 5, a schematic diagram of the internal components of the device 100 is shown. The device may include a complex arrangement of rollers and a feeding mechanism, all housed within a partly transparent blue outer casing. An arrow may indicate the direction of paper or material movement through the device.

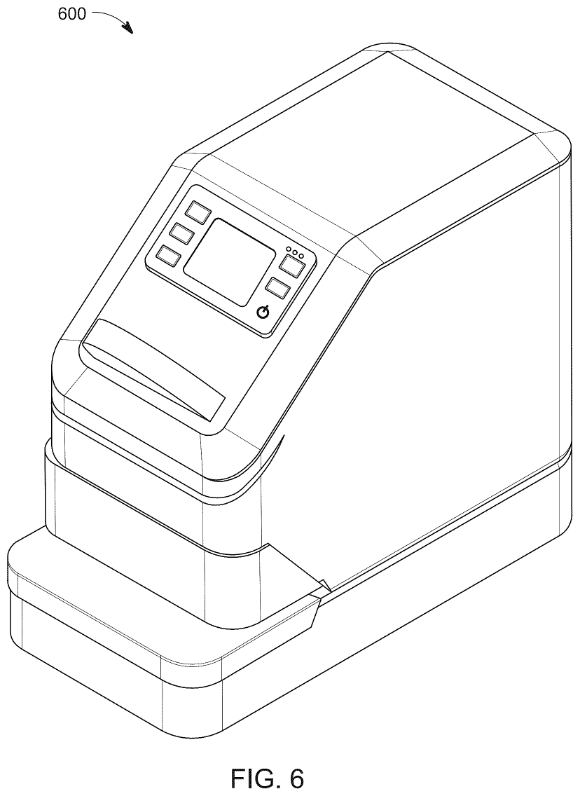

FIG. 6 provides an isometric view of the device, labeled as 600. The device may have a rectangular shape with a slanted top surface featuring a control panel. The panel may include several buttons and a central display screen.

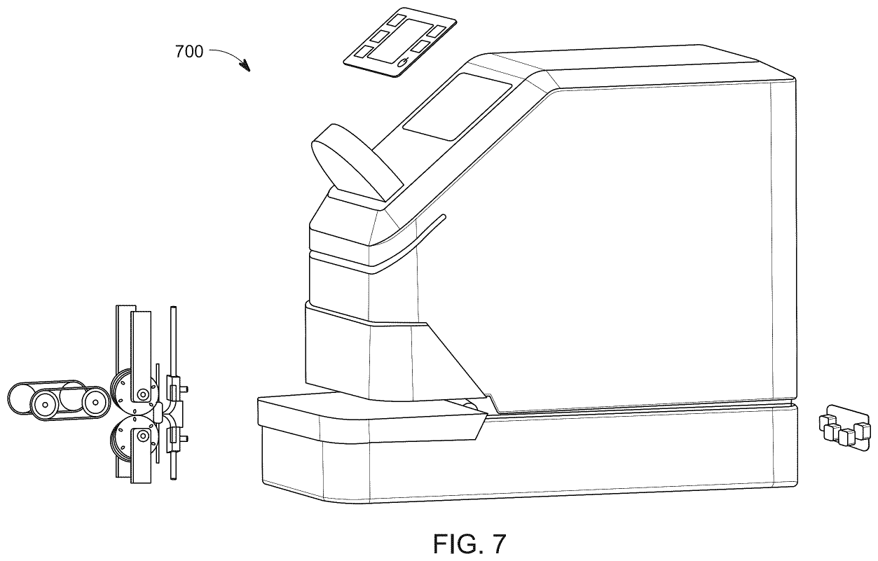

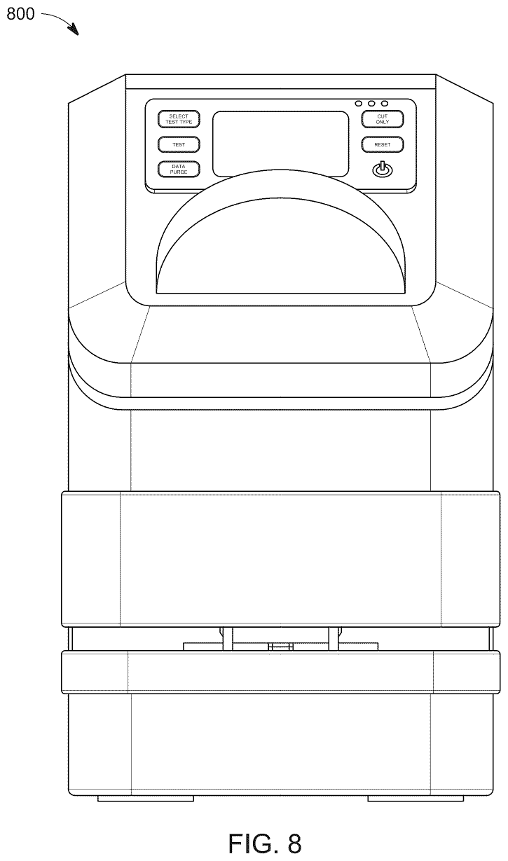

As illustrated in FIG. 7, an exploded view diagram of the device shows various components including a display, cutting mechanism, and panel port. This view provides insight into the internal structure and assembly of the device.

FIG. 8 presents a front view of the device, labeled as 800. The device may have a rectangular shape with a top panel featuring several buttons on each side and a small display screen in the center. Below the screen, there may be a semi-circular design element.

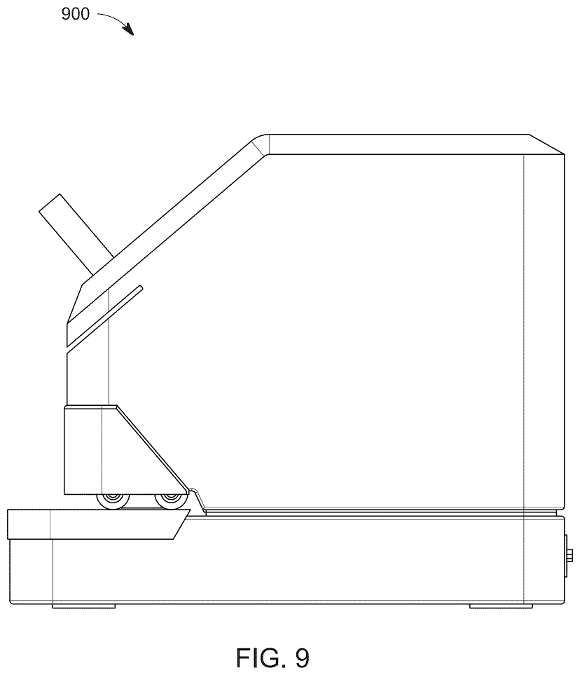

Referring to FIG. 9, a left side view of the device, labeled as 900, is shown. The device may have an angular and linear design, with a protruding section at the top and wheel-like components at the base.

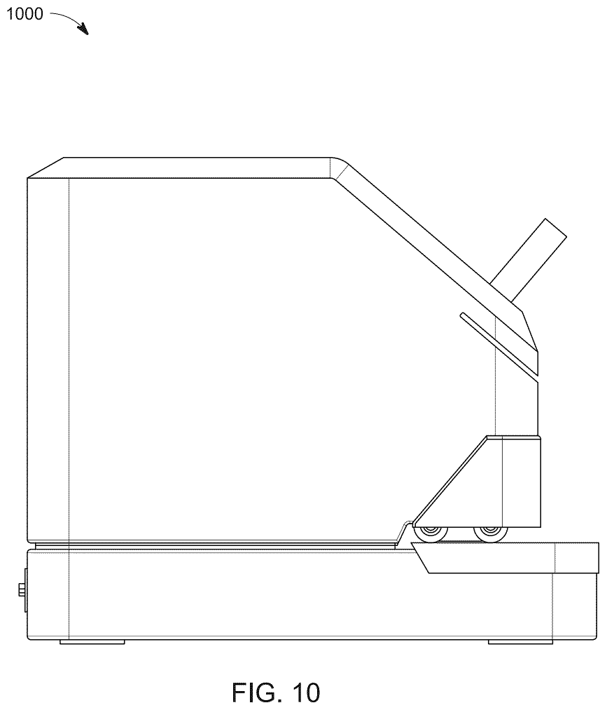

FIG. 10 depicts the right side view of the device, labeled as 1000. The device may have a rectangular base with a slanted top surface and may feature a protruding lever or handle positioned at an angle on the top side.

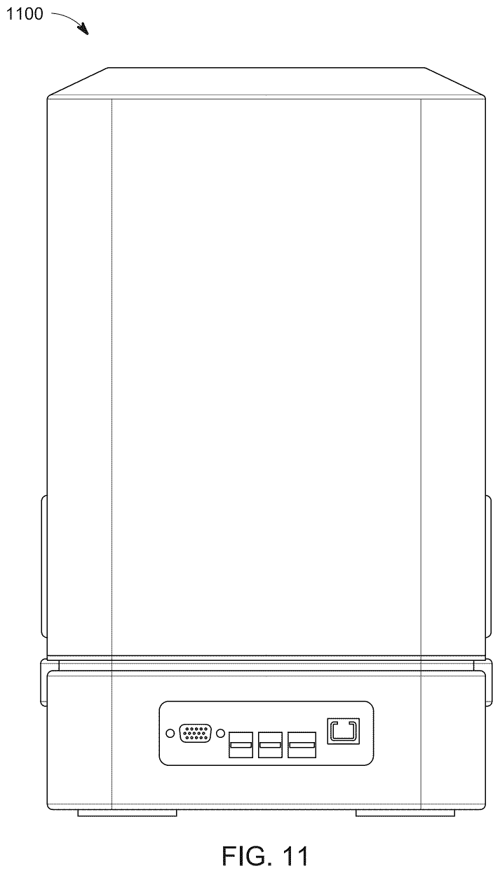

As shown in FIG. 11, the back view of the device, labeled as 1100, may include various ports such as a VGA port, two USB ports, and an Ethernet port, arranged horizontally in the bottom section.

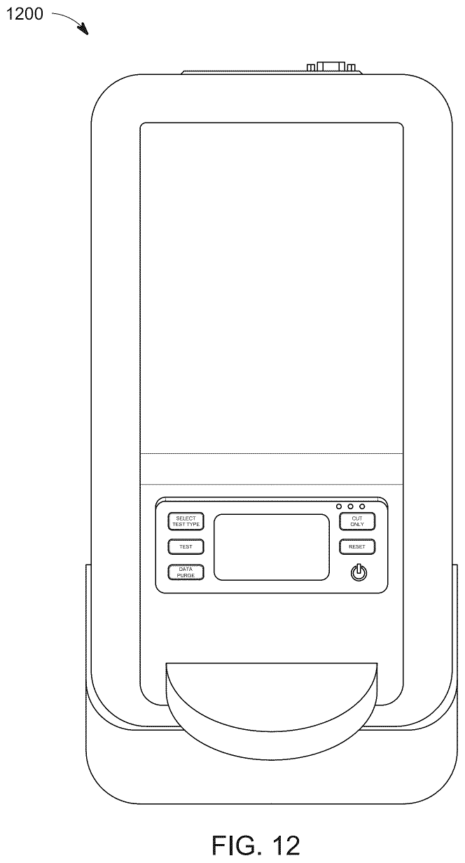

FIG. 12 presents a top view of the device, labeled as 1200. The device may have a rectangular shape with rounded corners and a central screen or display. Below the screen, there may be several buttons and controls, including a circle-shaped button.

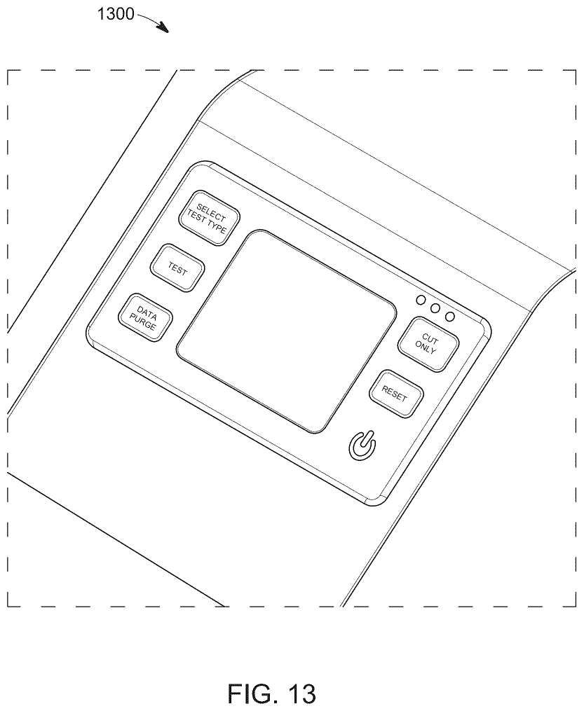

Referring to FIG. 13, a detailed view of the control panel interface labeled as “Display” is shown. The interface may feature several buttons surrounding a central rectangular display screen. The buttons may be labeled “DIRECT INPUT,” “TEST,” “DATA FEED,” “CUT ONLY,” and “SENSOR,” with a power symbol at the bottom right.

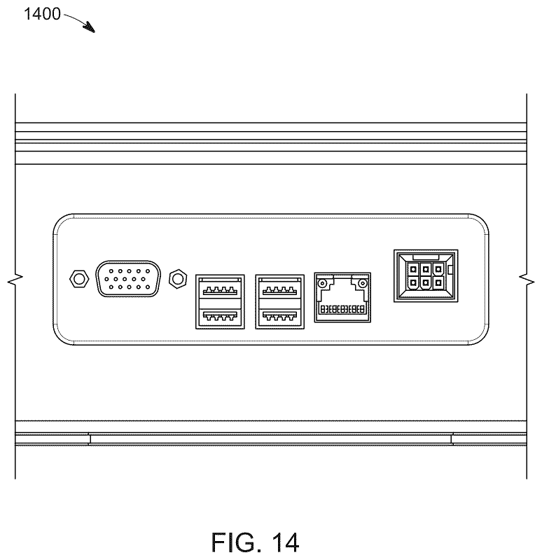

FIG. 14 illustrates a detailed view of the port panel, which may include a VGA port, two USB ports, an Ethernet port, and a power connector arranged horizontally across a rectangular panel.

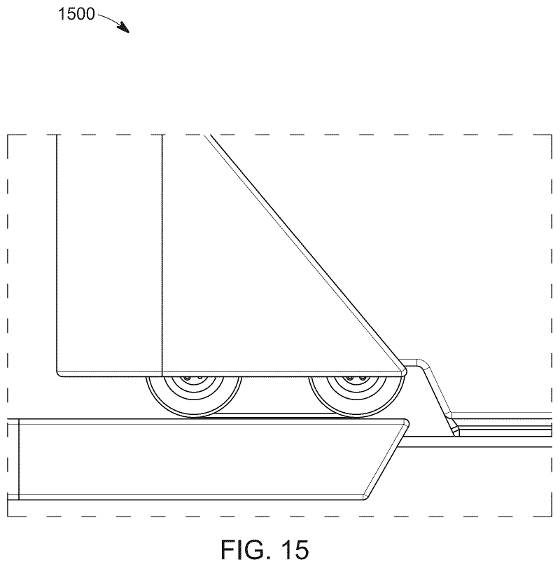

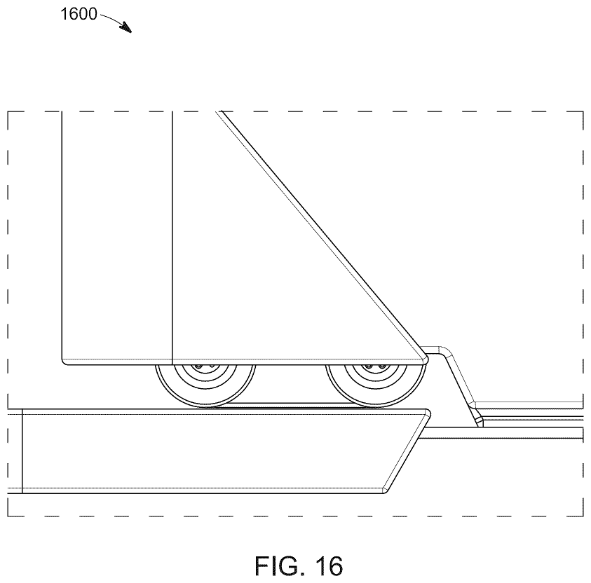

As shown in FIG. 15 and FIG. 16, the device may include an installed cutting mechanism. The mechanism may be mounted on a platform with wheels, showing an angled structure extending towards a surface.

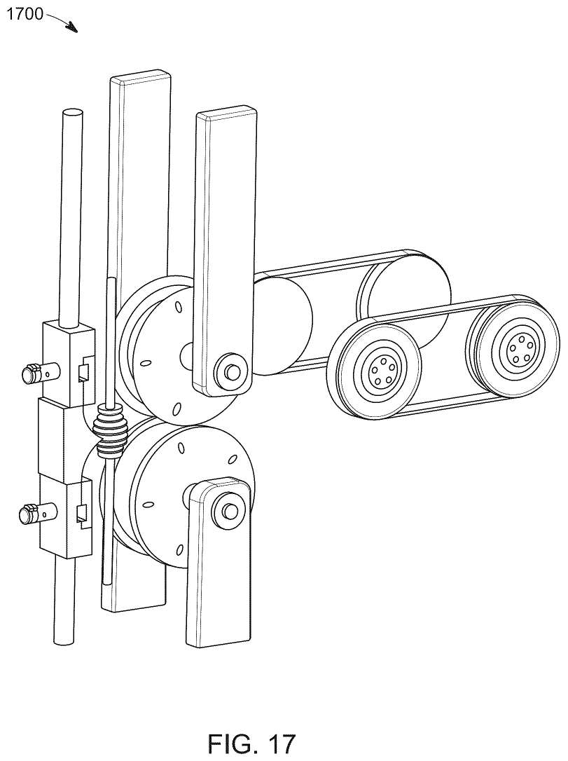

FIG. 17 depicts an isometric view of the mechanical assembly, labeled as 1700. The assembly may include a series of vertical and horizontal beams connected to circular elements, resembling wheels and pulleys.

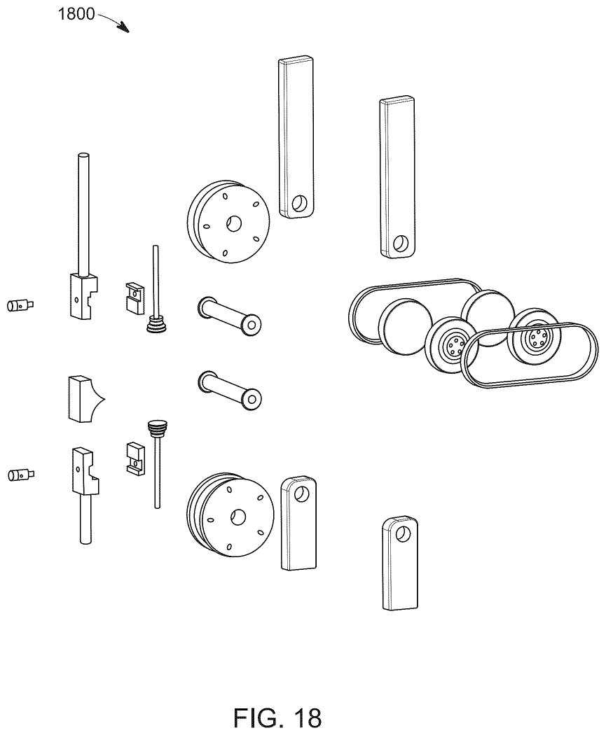

Referring to FIG. 18, an exploded view of the mechanical assembly is presented. This view shows how various components, including rods, circular discs, rectangular blocks, and a set of gears, fit together.

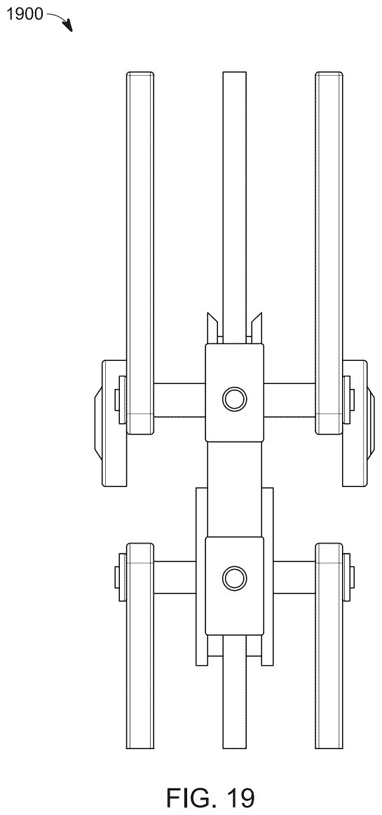

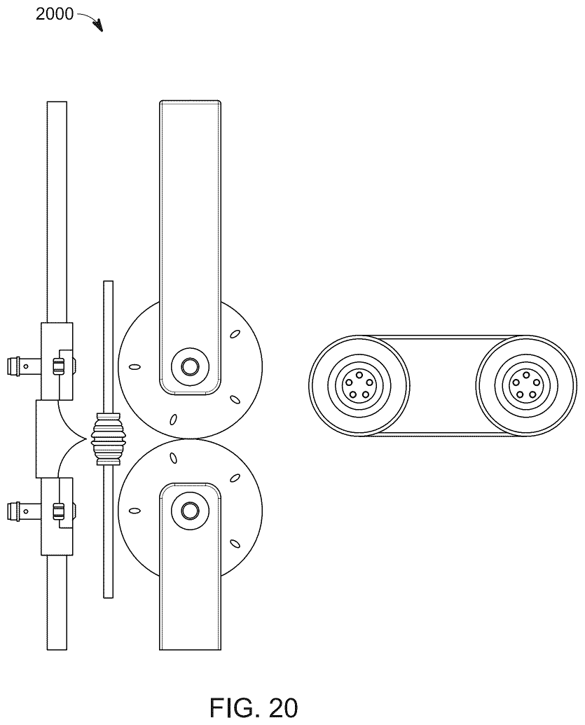

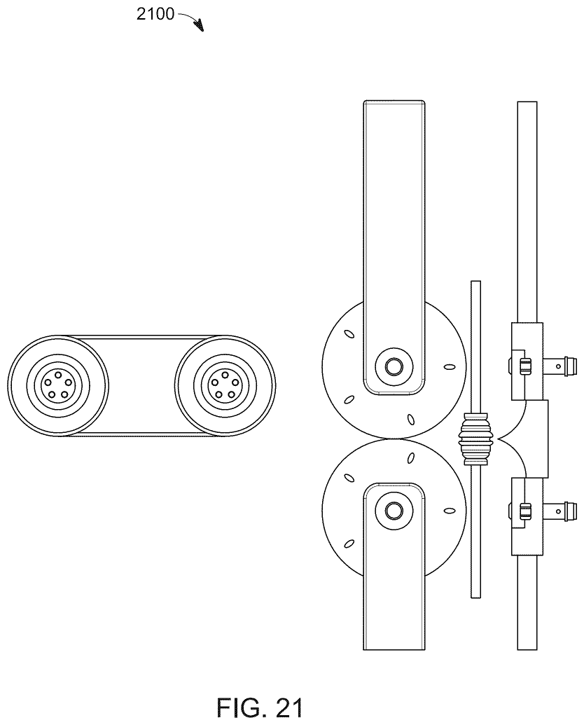

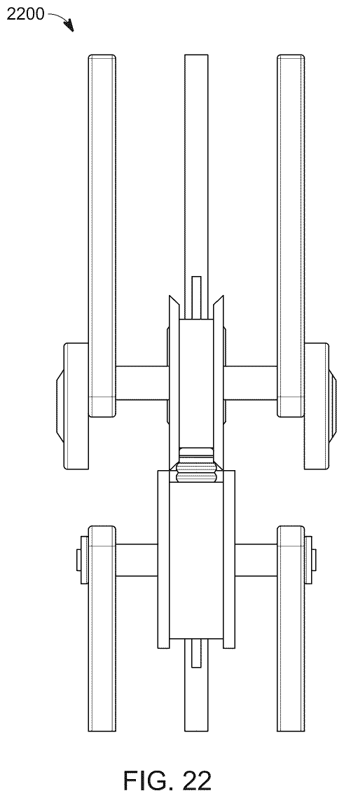

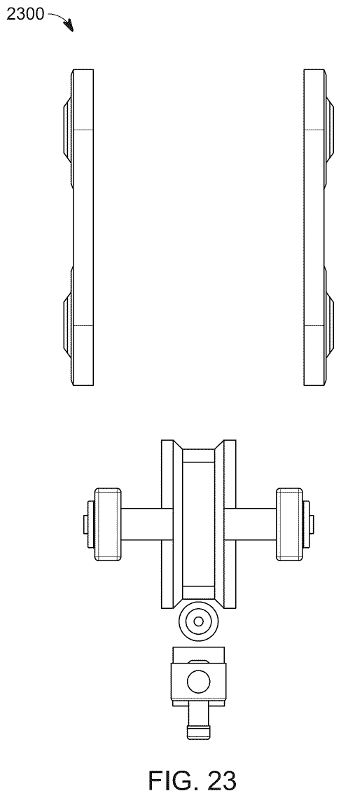

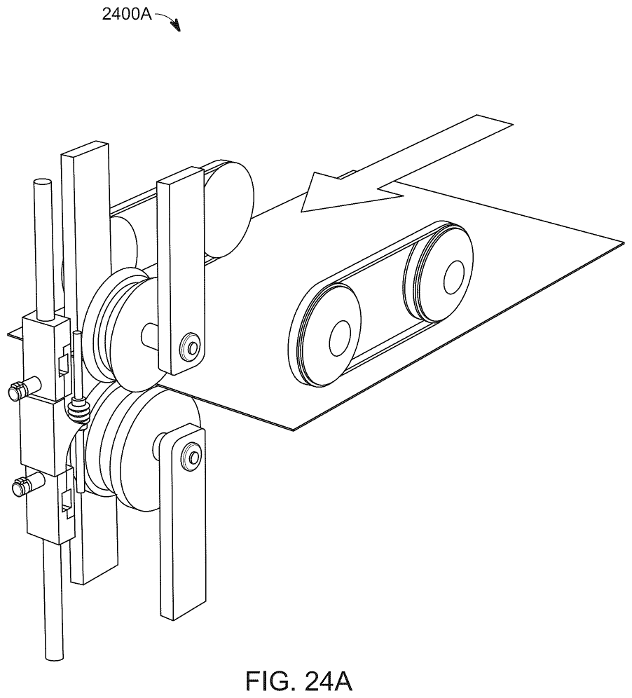

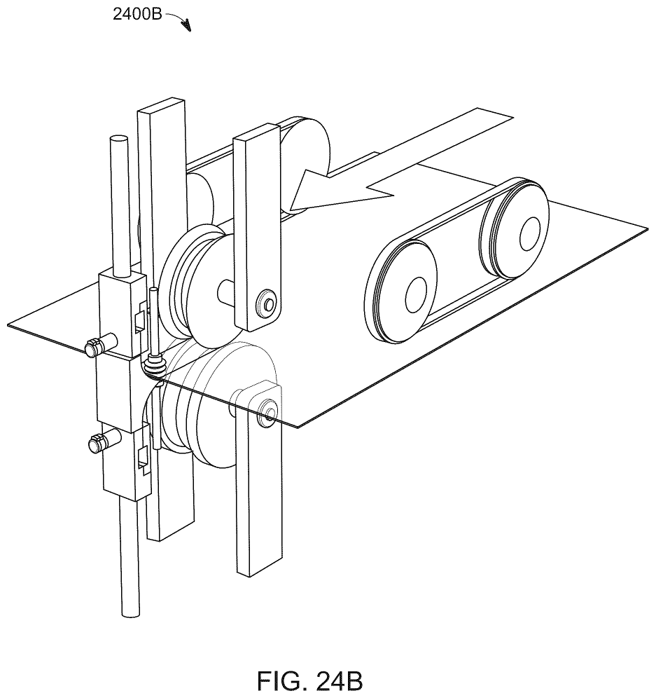

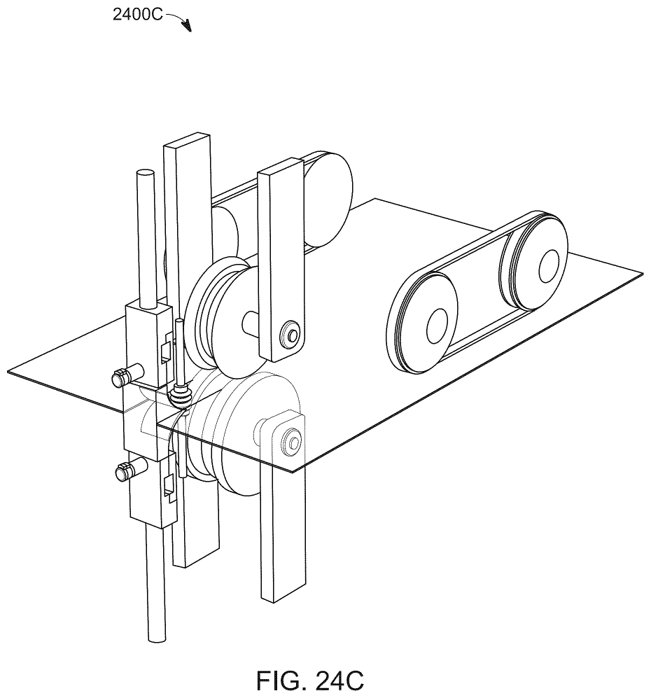

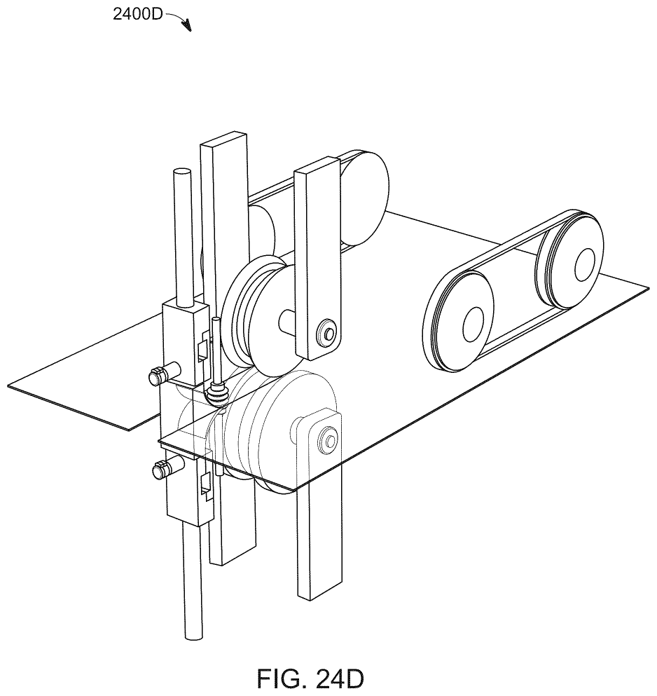

FIG. 19 through FIG. 23 provide various views (front, left, right, back, and top) of the mechanical apparatus, illustrating its symmetrical design and key components such as vertical and horizontal bars, circular plates, pulleys, and wheels.

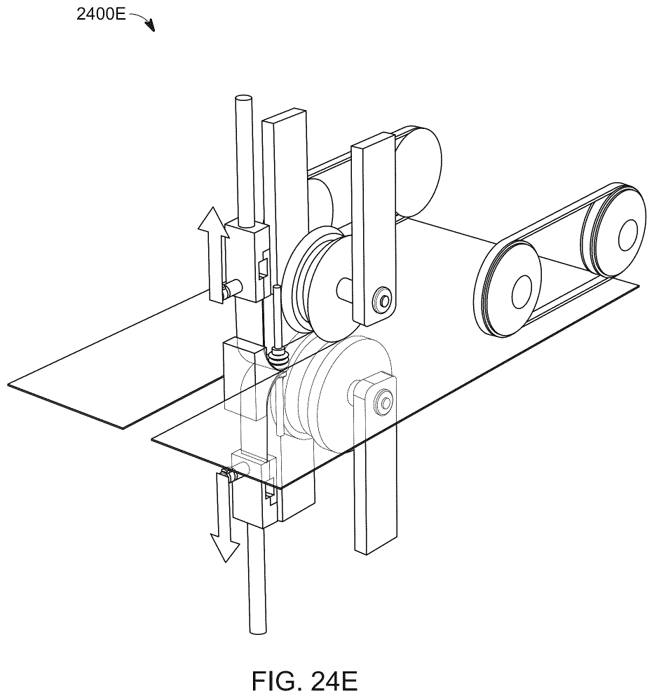

FIG. 24A-E illustrate the operation of the automatic pouch peel tester. As shown in FIG. 24A, the device may include cutting dies, machine grips, suction cups, grip motors, a split guide, and belts. FIG. 24B shows how a pouch may be fed by belts into cutting dies, creating a 1-inch-wide strip. FIG. 24C illustrates how automatic suction cups may pull apart the pouch as it is fed into a split guide. FIG. 24D shows how the pouch continues to be pulled and feeds into the machine grips. Finally, FIG. 24E depicts how the grips may close and pull the pouch material apart to measure the strength of the seal.

The invention being thus described, it will be evident that the same may be varied in many ways by any one having skill in the applicable arts. Such variations are not to be regarded as a departure from the spirit and scope of the invention and all such modifications are intended to be included within the scope of the claims.

The automatic medical pouch peel/tensile testing device may comprise a housing that contains the internal components and mechanisms for performing the peel/tensile tests on medical pouches. The housing may have a generally rectangular shape with rounded edges and a slanted top surface. The slanted top surface may include a touchscreen display panel for user interaction and control of the device.

The device may include a feeding mechanism for automatically loading medical pouches or pouch samples into the testing area. This feeding mechanism may comprise a series of rollers and belts to transport the pouches through the device. A cutting mechanism may be incorporated to automatically cut the pouches into standardized test strips of a specified width, such as 1-inch wide strips, in accordance with ASTM F-88 test standards.

The testing mechanism may include machine grips or clamps for securely holding the pouch sample during the peel or tensile test. These grips may be motorized to apply the pulling force needed to separate the pouch seal. Suction cups may be utilized to initially separate the pouch layers and feed them into a split guide that directs each layer into the appropriate machine grip. Force sensors may be integrated into the gripping mechanism to measure the force required to separate the pouch seal during testing. Position or displacement sensors may also be included to track the progress of the peeling action. The device may incorporate a control system, likely microprocessor-based, to coordinate the automated testing process and collect data from the various sensors.

A data storage component may be included to record and retain the test results and raw sensor data for later analysis. The touchscreen display on the top panel may serve as the primary user interface, allowing the operator to initiate tests, view results, and access stored data. The device may also include various communication ports on the rear panel, such as USB, Ethernet, and VGA, to facilitate data transfer and external display connections.

The entire testing process—from pouch loading to data recording—may be automated to minimize human intervention and reduce potential sources of error. This automation may allow for more frequent testing and improved accuracy compared to manual testing methods. The automatic medical pouch peel/tensile testing device may include a data storage and analysis system for recording and evaluating test results. This system may comprise a memory unit for storing raw sensor data and processed test metrics from each peel/tensile test performed. The memory unit may be integrated within the device housing or may be a removable storage medium such as a memory card or USB drive. The data storage system may organize test results by date, batch number, pouch type, or other relevant parameters. This organization may allow for easy retrieval and analysis of historical test data. The system may also include data backup and redundancy features to prevent loss of critical quality control information.

In addition to raw data storage, the device may incorporate data analysis capabilities. These capabilities may include statistical analysis tools for calculating average seal strength, identifying trends over time, and flagging any results that fall outside of predefined quality thresholds. The analysis system may generate reports summarizing test results for a given time period or production batch. The data analysis functions may be performed by a microprocessor or dedicated signal processing unit within the device. Alternatively, the device may interface with external computer systems to offload data for more advanced analysis. This interfacing may occur via wired connections such as USB or Ethernet ports, or through wireless protocols like Wi-Fi or Bluetooth.

To facilitate data review and analysis, the device may include graphical display capabilities on its integrated touchscreen interface. These displays may include real-time force vs. displacement graphs during testing, as well as historical trend charts and statistical summaries. The user interface may allow operators to filter and sort stored data based on various criteria. The data storage and analysis system may also support quality assurance and regulatory compliance efforts. It may include features for data integrity verification, audit trails of user actions, and export functions for providing test records to regulatory bodies or customers. The system may be designed to comply with relevant data security and privacy regulations in the medical device industry.

By providing comprehensive data management capabilities, the automatic medical pouch peel/tensile testing device may enable manufacturers to optimize their quality control processes, identify potential issues early, and maintain detailed records for regulatory compliance. The integration of data storage and analysis features with the automated testing functions may create a more streamlined and reliable approach to medical pouch seal integrity verification. The automatic medical pouch peel/tensile testing device may include a data storage and analysis system. This system may comprise an integrated or removable memory unit for storing test results. The memory unit may organize data by date, batch, and pouch type to facilitate easy retrieval and analysis.

The data storage system may incorporate backup and redundancy features to ensure data integrity and prevent loss. Statistical analysis tools may be included to process the stored data and generate insights on seal quality trends over time. The system may have report generation capabilities to summarize test results in various formats. A graphical display on the touchscreen interface may allow users to visualize test data through charts, graphs, and other visual representations. The device may offer external computer interfacing options via USB, Ethernet, or other ports to enable data transfer and more advanced analysis on separate systems.

The comprehensive data management capabilities may support quality assurance processes and regulatory compliance efforts. Manufacturers may be able to maintain detailed testing records and demonstrate consistent seal integrity verification procedures. The integration of automated testing with robust data handling may create a more streamlined approach to medical pouch quality control. The data analysis tools may allow identification of potential issues or trends in seal quality before they become critical problems. By providing both immediate test results and long-term data insights, the device may enable proactive quality management for medical pouch manufacturing operations. The combination of precise automated testing and powerful data analytics may represent a significant advancement over traditional manual testing and record-keeping methods. The automatic medical pouch peel/tensile testing device may comprise a housing that encloses the internal components. The housing may have a generally rectangular shape with rounded edges and a slanted top surface. A touchscreen display panel may be provided on the slanted top surface to serve as a user interface.

The device may include a feeding mechanism to automatically feed medical pouches into the testing area. This feeding mechanism may utilize rollers and belts to move the pouches through the device. A cutting mechanism may be provided to cut standardized test strips from the pouches. This cutting mechanism may include cutting dies configured to create 1-inch wide strips from the pouches. The device may incorporate machine grips or clamps for holding the pouch samples during testing. These grips may be coupled to a motorized grip system capable of applying a controlled pulling force to the samples. Suction cups may be included to facilitate initial separation of the pouch layers. A split guide may direct the separated pouch layers into the machine grips. Force and position sensors may be incorporated to take precise measurements during the testing process. These sensors may provide data on the force required to separate the pouch seal as well as the displacement of the grips.

A control system may coordinate the overall testing process. This control system may include a microprocessor to manage the various mechanisms and collect data from the sensors. The touchscreen display may serve as the primary user interface, allowing the operator to initiate tests, view results, and access stored data. The device may include memory storage capabilities to retain raw sensor data as well as processed test metrics. This data may be organized by parameters such as date, batch number, and pouch type. The system may incorporate backup and redundancy features to protect stored data. Connectivity options such as USB, Ethernet, and VGA ports may be provided to facilitate data transfer and connection to external displays or computer systems. These ports may be located on a rear panel of the device housing.

The typical operation sequence may proceed as follows: A pouch may be fed by the belts into the cutting dies where a 1-inch wide strip is created. Suction cups may then pull apart the pouch layers, feeding them into the split guide. The separated layers may then feed into the machine grips. The grips may close on the sample and apply a pulling force to measure the seal strength. During testing, the device may generate real-time force versus displacement graphs. The system may also be capable of producing historical trend charts and statistical summaries of stored test data. Filtering and sorting functions may allow for customized analysis of the recorded information. The data management capabilities may support quality assurance processes and regulatory compliance efforts. Features such as data integrity verification and audit trails may be included to meet industry standards.

By automating the testing process and providing robust data analysis tools, the device aims to minimize human error, improve measurement accuracy, and streamline quality control procedures for medical pouch manufacturers. The combination of precise automated testing and comprehensive data analytics may represent an advancement over traditional manual testing methods. The automatic medical pouch peel/tensile testing device may include a data analysis and reporting system. This system may store and process the test results from multiple pouch samples. The data analysis system may include a memory unit for storing raw sensor data and processed metrics from each test. The system may organize results by date, batch number, pouch type, or other relevant parameters.

The data storage may incorporate backup and redundancy features to ensure data integrity. The analysis capabilities may include statistical tools to identify trends or anomalies across multiple tests. The system may generate reports summarizing test results, including graphical displays of data. These reports may be customizable to meet specific quality control or regulatory requirements. The device may provide connectivity options to interface with external systems. This may include USB, Ethernet, and VGA ports to allow data transfer, remote monitoring, or connection to external displays. The connectivity features may enable integration with broader quality management systems used in medical device manufacturing. To support quality assurance processes, the device may incorporate features for data integrity verification and maintaining audit trails. The system may allow authorized users to review and approve test results. Export functions may be provided to transfer data to other systems for further analysis or archiving. The user interface of the device may include a touchscreen display panel. This interface may allow operators to initiate tests, view results, access stored data, and configure device settings. The display may present real-time information during testing as well as summaries of completed test batches.

By automating the testing process and providing robust data analysis tools, the device may minimize human error, improve measurement accuracy, and streamline quality control procedures for medical pouch manufacturers. The combination of precise automated testing and comprehensive data analytics may represent an advancement over traditional manual testing methods. The grips may close and apply a pulling force to the pouch material in order to measure the strength of the seal. The device may include force sensors to quantify the force required to separate the sealed layers of the pouch. This testing process may allow for evaluation of seal integrity in accordance with standardized test methods. The grips may close and apply a pulling force to the pouch material in order to measure the strength of the seal. The device may include force sensors to quantify the force required to separate the sealed layers of the pouch. This testing process may allow for evaluation of seal integrity in accordance with standardized test methods.

The automatic medical pouch peel/tensile testing device may comprise a housing structure that encloses and supports the various mechanical and electronic components. The housing may have a rectangular shape with rounded edges and a slanted top surface to facilitate user interaction. A touchscreen display panel may be integrated into the top surface to provide a user interface for operating the device and viewing test results. The device may include a feeding mechanism with rollers and belts to automatically transport medical pouches through the testing process. This feeding system may precisely control the movement of pouches from the input area through the cutting, separation, and testing stages.

A cutting mechanism may be incorporated to create standardized test strips from the medical pouches. This mechanism may utilize precision dies capable of consistently producing 1-inch-wide strips as specified in relevant testing standards. The cutting system may be designed to minimize damage to the pouch seal during the strip creation process. The device may feature machine grips with a motorized system for applying controlled pulling forces to the pouch samples. These grips may be designed to securely hold the separate layers of the pouch without slipping or causing damage to the material. The motorized system may allow for precise control of the applied force and displacement during testing.

To facilitate the initial separation of pouch layers, the device may incorporate suction cups. These suction cups may gently grip and pull apart the unsealed portions of the pouch to prepare it for testing. A split guide may then be used to direct the separated layers into the machine grips for tensile testing. The testing apparatus may be equipped with force and position sensors to enable precise measurements throughout the peel/tensile test. These sensors may provide real-time data on the force required to separate the pouch seal and the displacement of the grips during testing. This data may be used to generate force-displacement curves and calculate key metrics such as seal strength and elongation.

A microprocessor-based control system may be implemented to coordinate the various mechanical components and process sensor data. This control system may manage the sequencing of operations, control motor movements, process sensor inputs, and perform data analysis. The microprocessor may also handle user interface functions and manage data storage and retrieval. The device may incorporate robust data storage and analysis capabilities. Test results, including raw sensor data and processed metrics, may be stored in non-volatile memory for later retrieval and analysis. The data management system may organize test results by date, batch number, pouch type, or other relevant parameters to facilitate quality control processes.

To support integration with external systems and data transfer, the device may include various connectivity options. USB ports, Ethernet connections, and VGA outputs may be provided to allow for data export, software updates, and connection to external displays or computers. These connectivity features may enhance the device's flexibility and utility in different laboratory or production environments.

The automatic medical pouch peel/tensile testing device may represent an advancement over traditional manual testing methods by combining precise automated testing with comprehensive data analytics. By automating the cutting, loading, and peeling processes, the device may minimize human error and improve measurement consistency. The integration of data storage, analysis, and reporting features may streamline quality control procedures and provide manufacturers with more comprehensive insights into their product performance.

The automatic medical pouch peel/tensile testing device may comprise a rectangular housing with rounded edges and a slanted top surface. The housing may include a touchscreen display panel on the upper surface for user interface and control. The device may have a feeding mechanism with rollers and belts to transport medical pouches through the testing process. A cutting mechanism with dies may be provided to create 1-inch-wide test strips from the medical pouches. The cutting mechanism may be mounted on a platform with wheels for mobility and adjustment.

The device may include machine grips with a motorized system to apply controlled pulling force during testing. Suction cups may be utilized for initial separation of the pouch layers. A split guide may be incorporated to direct the separated pouch layers into the machine grips. Force and position sensors may be integrated to enable precise measurements during the peel/tensile test. A microprocessor-based control system may coordinate the testing sequence and process measurement data. The device may have data storage and analysis capabilities, with test results organized by date, batch, and pouch type. Connectivity options such as USB, Ethernet and VGA ports may be provided for data transfer and external display.

The automated testing sequence may involve feeding the pouch, cutting test strips, separating layers, gripping, and applying controlled pulling force. Real-time force vs. displacement graphs may be generated during testing. The combination of automated sample preparation, testing, and comprehensive data collection may enable more frequent and consistent quality checks compared to manual methods. This may allow for trend analysis and early detection of potential seal integrity issues in medical pouch manufacturing.

The automatic medical pouch peel/tensile testing device described herein may provide significant advantages over manual testing methods for evaluating the seal integrity of medical pouches. By automating the cutting, loading, and peeling processes, the device may minimize human error and improve measurement consistency. The integration of precision sensors, data storage, and analysis capabilities may enable more comprehensive and reliable quality control procedures.

The device may be configured to perform standardized tests such as ASTM F-88 peel or tensile tests on medical pouch seals. Key components may include a cutting mechanism to prepare standardized test specimens, a loading mechanism to position samples, gripping/peeling mechanisms to apply controlled forces, force and displacement sensors to measure seal strength, and a control system to coordinate operations and process data.

While specific embodiments have been described, it will be understood that various modifications may be made without departing from the spirit and scope of the invention. For example, the specific mechanical configurations, sensor types, data analysis algorithms, and user interface designs may be varied to suit particular applications or manufacturing environments. The device may also be adapted to test other types of sealed packaging beyond medical pouches.

The automated nature of the device may allow for more frequent testing and collection of larger datasets compared to manual methods. This may enable more robust statistical analysis and early detection of trends or anomalies in seal quality. The onboard data storage and connectivity options may facilitate integration with broader quality management systems. By providing a standardized, repeatable testing process with minimal human intervention, the device aims to improve the reliability and efficiency of medical pouch seal integrity verification. This may ultimately contribute to enhanced quality assurance for sterile medical packaging.

The invention being thus described, it will be evident that the same may be varied in many ways by anyone having skill in the applicable arts. Such variations are not to be regarded as a departure from the spirit and scope of the invention and all such modifications are intended to be included within the scope of the claims.

What is claimed:

1. An automatic medical pouch peel/tensile testing device, comprising:
a cutting mechanism configured to automatically cut a medical pouch to prepare a test specimen;
a loading mechanism configured to automatically load the test specimen into a testing apparatus;
a peeling mechanism configured to apply a controlled increasing force to separate a seal of the test specimen;
one or more sensors configured to monitor force applied during testing of the test specimen;
a memory configured to store test data; and
a controller configured to:
control operation of the cutting mechanism, loading mechanism, and peeling mechanism;
receive force measurements from the one or more sensors; and
store the force measurements in the memory.

2. The device of claim 1, wherein the cutting mechanism comprises cutting dies configured to cut the medical pouch into a standardized size test specimen.

3. The device of claim 1, wherein the loading mechanism comprises suction cups configured to grip and position the test specimen.

4. The device of claim 1, wherein the peeling mechanism comprises machine grips configured to securely hold opposing sides of the test specimen seal.

5. The device of claim 1, wherein the one or more sensors comprise force measurement sensors configured to continuously monitor applied force during testing.

6. The device of claim 1, further comprising a display configured to present a user interface for controlling the device and viewing test results.

7. The device of claim 1, wherein the controller is further configured to:
generate force versus displacement data based on the force measurements; and
calculate one or more seal integrity metrics based on the force versus displacement data.

8. The device of claim 7, wherein the one or more seal integrity metrics comprise at least one of: peak force, average force, or seal failure point.

9. The device of claim 1, wherein the controller is further configured to compare test results to predetermined standards.

10. The device of claim 9, wherein the predetermined standards comprise ASTM F-88 peel or tensile test standards.

11. A method for automatically testing medical pouch seal integrity, comprising:
automatically cutting, by a cutting mechanism, a medical pouch to prepare a test specimen;
automatically loading, by a loading mechanism, the test specimen into a testing apparatus;
applying, by a peeling mechanism, a controlled increasing force to separate a seal of the test specimen;
monitoring, by one or more sensors, force applied during testing of the test specimen;
storing force measurements from the one or more sensors in a memory; and
controlling, by a controller, operation of the cutting mechanism, loading mechanism, and peeling mechanism.

12. The method of claim 11, further comprising:
generating force versus displacement data based on the force measurements; and
calculating one or more seal integrity metrics based on the force versus displacement data.

13. The method of claim 12, wherein the one or more seal integrity metrics comprise at least one of: peak force, average force, or seal failure point.

14. The method of claim 11, further comprising comparing test results to predetermined standards.

15. The method of claim 14, wherein the predetermined standards comprise ASTM F-88 peel or tensile test standards.

16. The method of claim 11, wherein automatically cutting the medical pouch comprises cutting the pouch into a standardized size test specimen using cutting dies.

17. The method of claim 11, wherein automatically loading the test specimen comprises gripping and positioning the test specimen using suction cups.

18. The method of claim 11, wherein applying the controlled increasing force comprises securely holding opposing sides of the test specimen seal with machine grips.

19. The method of claim 11, further comprising presenting a user interface on a display for controlling the testing process and viewing test results.

20. A non-transitory computer-readable medium storing instructions that, when executed by a processor, cause the processor to perform operations comprising:
controlling a cutting mechanism to automatically cut a medical pouch to prepare a test specimen;
controlling a loading mechanism to automatically load the test specimen into a testing apparatus;
controlling a peeling mechanism to apply a controlled increasing force to separate a seal of the test specimen;
receiving force measurements from one or more sensors monitoring force applied during testing of the test specimen;
storing the force measurements in a memory;
generating force versus displacement data based on the force measurements;
calculating one or more seal integrity metrics based on the force versus displacement data; and
comparing the one or more seal integrity metrics to predetermined standards to assess seal integrity of the medical pouch.
